(19) United States
(12) Patent Application Publication
(10) Pub. No.: US 2003/0107959 A1
(43) Pub. Date: Jun. 12, 2003

(54) Recordable compact disk writing and playing apparatus

(76) Inventors: Kenneth Hamilton Norton, Edinburgh (GB); Anthony Combe, Dunfermline (GB)

Correspondence Address: SALTAMAR INNOVATIONS, 30 FERN LANE, SOUTH PORTLAND, ME, 04106, US

(21) Appl. No.: 10/149,351

(22) PCT Filed: Dec. 11, 2000
(86) PCT No.: PCT/GB00/04719

(30) Foreign Application Priority Data
Dec. 9, 1999 (GB) 9929003.3

(51) Int. Cl. G11B 7/00

(52) U.S. Cl. 369/30.23; 369/53.29; 369/53.21

(57) ABSTRACT

Recordable compact disc player and media. Improved power consumption, aerodynamics and use of data compression allow large quantities of music to be stored and played back. Storage space is increased by recording information on the land and grooves of 8 cm recordable media. Aerodynamic guide vanes are provided on the disc enclosure interior and the discs are textured for improved aerodynamic performance. A play list and play list is browser is further provided and media can also be visibly labeled whilst written, providing a storage device with a visible fingerprint or identifier characteristic of the owner.

The present invention relates to the field of recordable compact disk technology, especially rewritable compact disk technology (CD-RW). The invention relates further to apparatus for reading and writing CD-RW media, including improvements in multi-application CD-RW players.

Recently, audio players which store information in compressed audio format on solid-state memory devices have become popular. An example compressed audio format is MP3. Users of these devices can download music from e.g. the internet. At the present time, these devices are limited in storage capacity, a current best seller, the “Diamond Rio” has 32 Mb memory and can store around 30 minutes of sound. This is less than a conventional music album and limits its utility. The aim of this invention is to provide a better portable writable music storage system. In fact, it aims also to provide a better portable data storage system, enabling consumers to carry around computer files of all types, including computer games, digital still photos, video and the like and interact with other audio-visual systems, computers, networks and so forth.

The invention provides a portable CD-RW player configured for downloading and storing music and other data. This will have a much larger storage capacity than solid-state devices and at an inherently lower cost. These benefits will apply not just to the device but to the actual removable storage media themselves. An 80 mm Orange Book standard disc stores 180 Mb of data at a fraction of the cost of equivalent solid-state memory. Furthermore, there are already established convenient commercial outlets for the sale of titled discs for music, audio, video, software etc.

Another aim is to improve the storage capacity of CD players. A related aim is to reduce battery power consumption of such a device. These aims are related: for example, if storage capacity was improved, a smaller disc could be used (e.g. 8 cm format instead of 12 cm format), helping reduce power consumption.

Another aim is to provide a method for visibly labelling CD media. A yet further aim is to provide a way to allow the user to more conveniently select from the many files which can be stored on this type of device.

Unless context requires otherwise, the term “recordable compact disc” refers herein to any compact disc on which information can be recorded sequentially and includes both CD-R and CD-RW technology as well as DVD+RW etc where relevant.

According to a first aspect of the present invention there is provided a method for recording information on the land of a recordable compact disc comprising the steps of identifying a position in the groove of the recordable compact disc, microstepping onto the land adjacent to this position and recording information on the land from the resulting position onwards.

Preferably, the position in the groove of the recordable compact disc is established by reading position information from the data subcode Q field.

More preferably, the data recorded in the land is allocated a negative position reference, this reference being recorded in the program management area or table of contents.

According to a second aspect of the present invention there is provided a method for recording information on the land of a recordable compact disc comprising the steps of identifying a position in the land by recovering the wobble readback signal from parts of the groove adjacent to the land.

According to a third aspect of the present invention there is provided a method for recording visible text or images on the surface of a recordable compact disc comprising the steps of recording an array of visible pixel elements on the land of the recordable compact disc.

Preferably, visible pixel elements are recorded by abrating CD-R media.

Alternatively, visible pixel elements are recorded by laser induced phase changes on CD-RW media.

According to a fourth aspect of the present invention there is provided a double-sided CD-RW media wherein a groove and land pattern is provided on either side and an image is recorded by the method in the third aspect above thereby so as to enable the top and bottom sides to be differentiated.

According to a fifth aspect of the present invention, there is provided a personalised data storage media comprising a recordable compact disc with an image displayed thereon recorded by the method of the third aspect above, wherein said image acts to identify the authorised user of the personalised data storage media.

According to a sixth aspect of the present invention there is provided a method of saving power in a compact disc player comprising the step of reducing the playing speed to below the Orange book minimum speed and storing music thereon in a compressed data format.

According to a seventh aspect of the present invention there is provided a compact disc having a textured surface adapted to reduce the drag coefficient of the disc.

Preferably, the surface comprises a plurality of vortex generator means.

More preferably, the vortex generator means have the shape illustrated in FIG. 12.

According to an eighth aspect of the present invention there is provided a compact disc player comprising a solid-state memory buffer and a means for adapting the speed at which the compact disc is played.

Preferably, the means for adapting the speed at which the compact disc is played acts to maintain a constant data buffer size in the solid-state memory buffer.

Preferably also, the means for adapting the speed at which the compact disc is played monitors the rate at which playback errors are reported and adapts the speed to the lowest speed compatible with a given error rate.

According to a ninth aspect of the present invention there is provided a braking means for stopping the rotation of a compact disc in a compact disc player having a float hub, the braking means being integral to the float hub.

Preferably, the braking means is positively activated by lid closure.

According to a tenth aspect of the present invention there is provided a data storage device which has a personalised play list indicating the order in tracks or data files shall be played.

The tracks or data files may be audio, video, digital still photographs, presentation material or any other type of files which a user may wish to have played in a preferred order.

According to an eleventh aspect of the present invention there is provided a method for preparing a data storage device with a customised play list comprising the steps of selecting a plurality of tracks or data files and an order for playing said tracks or data files on a computer and then writing said list of tracks or data files and play order onto a data storage device.

Preferably, there is further selected and written on the data storage device information about an associated software application which can play said track or data file and the logical address where said track or data file is stored on said data storage device.

Data tracks may be recorded on the data storage device before or after recording play list information on the data storage device.

Further data tracks and play list information may be recorded on the data storage device thereafter.

The data tracks may be audio, video, digital still photographs, presentation material or any other type of files.

According to a twelfth aspect of the present invention there is provided a method for selecting for play a track or data file recorded on a data storage device wherein each track or data file has one or more alphanumeric identifiers, the method comprising the steps of inputting one or more alphanumeric characters, presenting a list of track or data files which have identifiers beginning with said character or characters to a user, inputting from a user an identifier of a particular track or data file and then playing said track or data file.

An alphanumeric identifier may be selected from a list consisting of: title, genre, artist, author.

According to a thirteenth aspect of the present invention there is provided a compact disc player having a disc enclosure interior, said enclosure interior having guide vanes thereon.

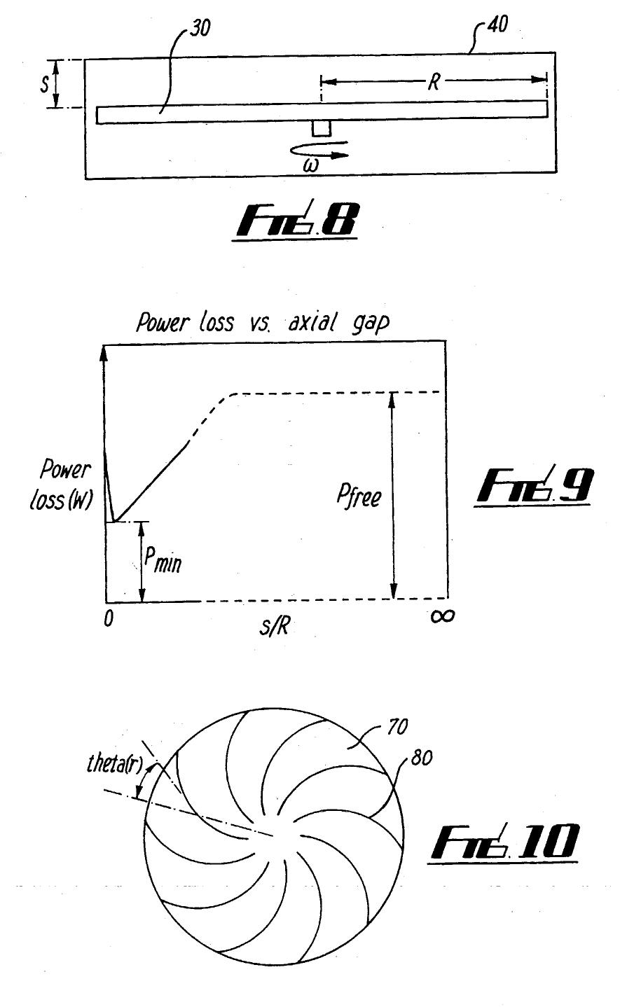

Preferably, the pattern of guide vanes is as shown in FIG. 10.

An example embodiment of the invention will now be illustrated with reference to the following Figures in which:

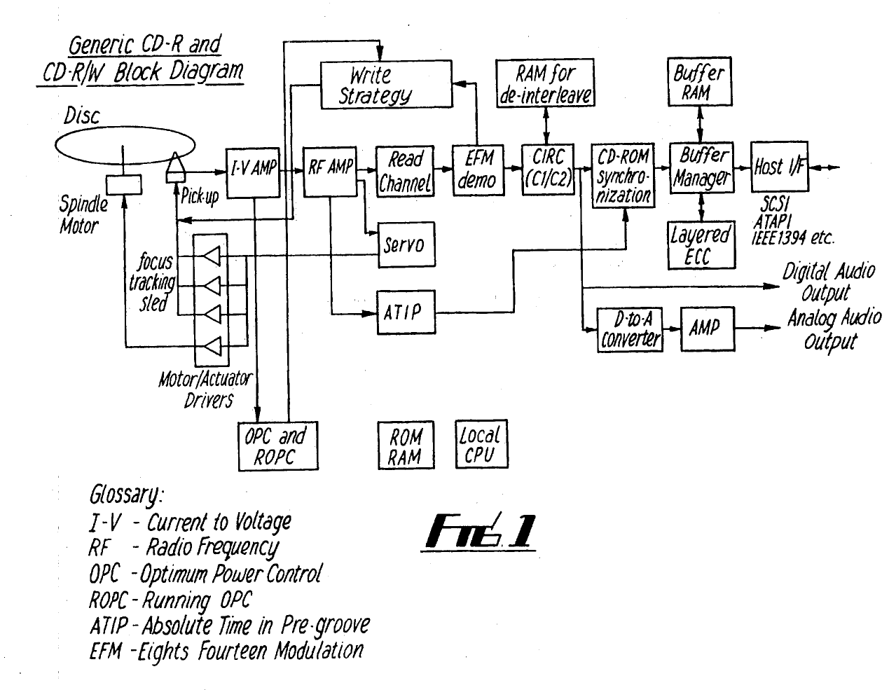

FIG. 1 shows a block diagram of components of a CD-R/CD-RW player;

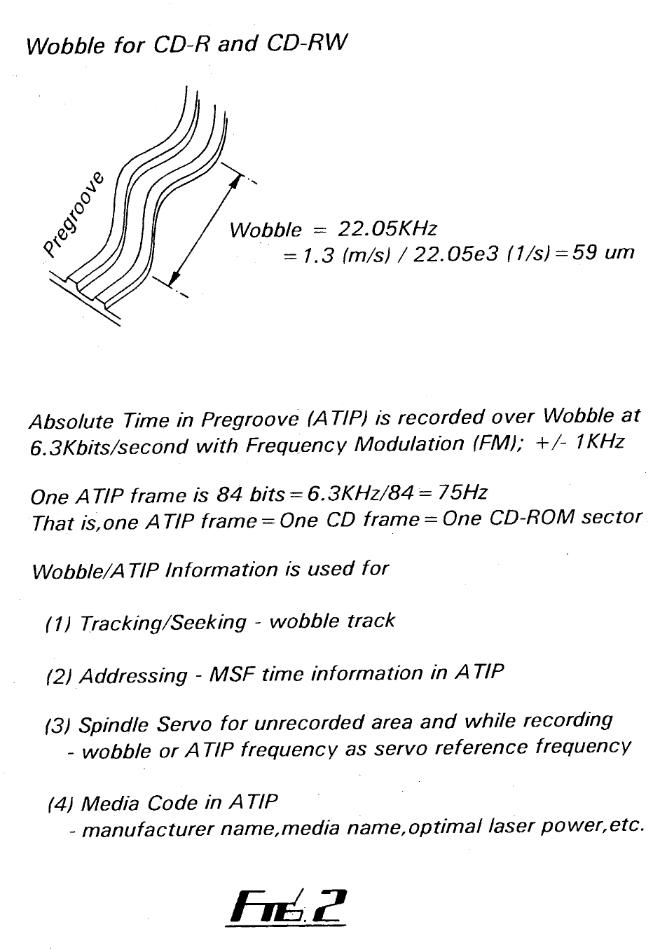

FIG. 2 shows groove wobble on the surface of a compact disc media in perspective view;

FIG. 3 describes the standard format for block addressing;

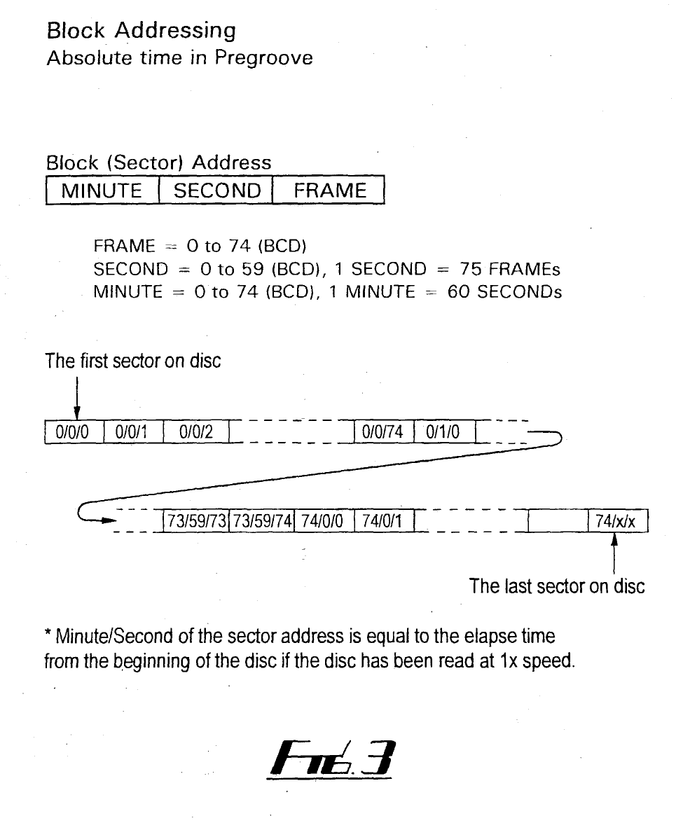

FIG. 4 is a cross-section through the substrate layer of a replicated CDR/CDRW;

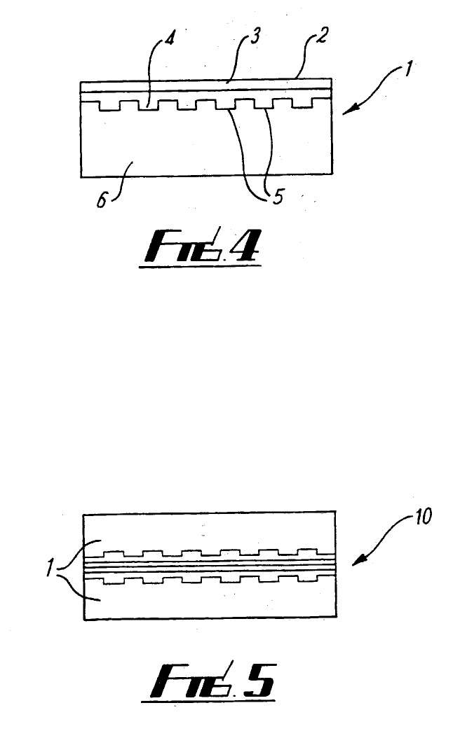

FIG. 5 shows how two of these substrate layers may be combined to give a two sided CDR/CDRW;

FIG. 6.shows in plan view examples of Fingerprinting/Watermarking and in expanded view the pit structure giving these images;

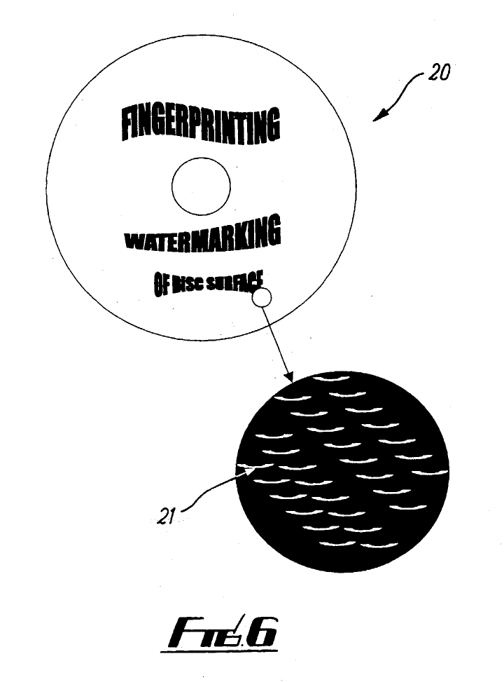

FIG. 7 is a graph comparing windage power loss for 8 cm and 12 cm discs;

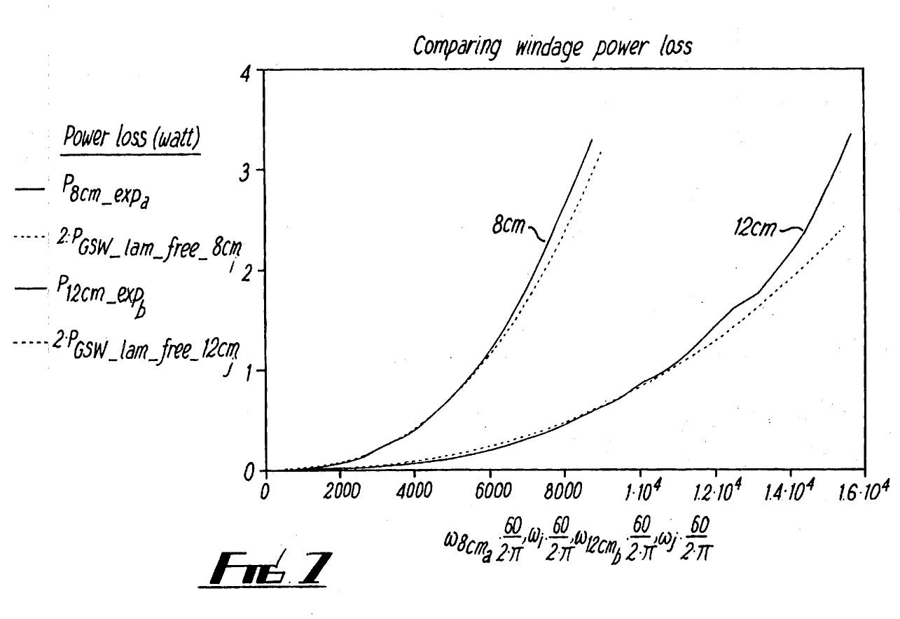

FIG. 8 illustrates in cross-section an example disc housing, labelling key dimensions S and R and angular speed ω;

FIG. 9 shows a figurative graph of the relationship between power loss and axial gap in the example disc housing of FIG. 8;

FIG. 10 shows a guide vane design for the disc enclosure interior;

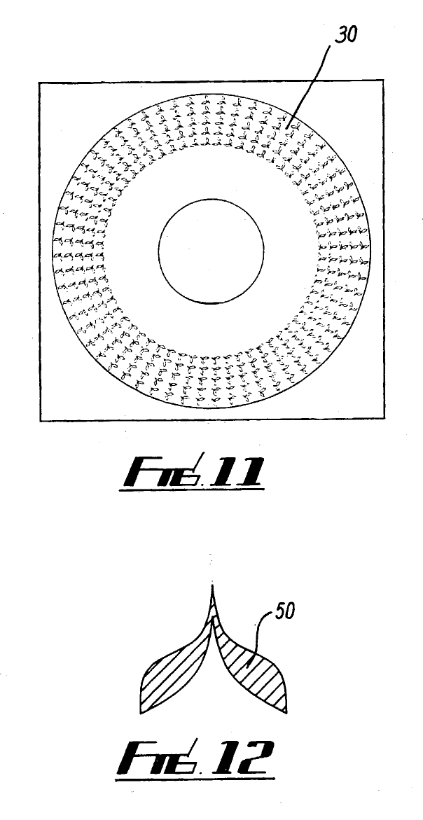

FIG. 11 illustrates in plan view a textured disc; and

FIG. 12 shows in plan view an individual vortex generator shape on a disc surface.

There is described here a recordable miniature compact disc writing system incorporating a multiplicity of features, some individual and some related, addressing the aims of: increasing the storage capacity; marking or witnessing the media to provide a visual record of disc content or a fingerprint identifying the owners; reducing power consumption; providing a means to mechanically brake disc rotation; creating title content lists (preferably updatable); and providing a title browser.

FIG. 1 shows a block diagram for an example CD-R/CD-RW player according to the present invention.

Extended Play Option.

The present art in CD recording allows data to be recorded onto a disk with a land and groove structure. The groove is an indented spiral, with the land being, in the present context, the ridges left between the grooves. The groove and land are typically the same material. This structure being necessary for the steering of the servo when the disks have not been recorded with data. These disks are then recorded with data within the grooves with the land being left unrecorded. The proposed design will extend the play of either a data recording device, a compressed audio music player or a standard Red Book Audio player by writing on both the land and groove. The implementation is far from trivial in that the invention has had to develop and new approach to successfully increase storage capacity.

In the present embodiment defined in the ‘Orange Book’ standard, the absolute position on the disk is recorded in the groove by radial wobbling the groove at a frequency of 22.05 KHz (carrier frequency) this frequency being digitally modulated by a bi-phase mark. When demodulated by electronics this signal provides an absolute position specified as a time, in minutes Seconds and frames, from the start of the spiral track at the ID, with the disk is rotating at a constant linear velocity of 1.3 m/sec. This value is referred to in the ‘Orange Book’ as ATIP (absolute time in pre-groove). The ATIP carrier frequency is used for speed regulation, the ATIP data encoded in the wobble provides an absolute position on the disc for the recording of data. Groove wobble is shown in perspective view in FIG. 2. In the example, wobble is 22.05 khz, having a 59 micrometre wavelength at 1.3 m/s rim rotation. ATIP is recorded over wobble at 6.3 Kb/second with Frequency modulation ±1 KHz. Each ATIP frame is 84 bits.

ATIP is recorded over Wobble at 6.3 Kbits/second with Frequency Modulation (FM); ±1 KHz. One ATIP frame is 84 bits=6.3 KHz/84=75 Hz. That is, one ATIP frame =One CD frame=One CD-ROM sector. Wobble/ATIP information is used for (1) Tracking/Seeking—wobble track; (2) Addressing—MSF time information in ATIP; (3) Spindle Servo for unrecorded area and while recording—wobble or ATIP frequency as servo reference frequency; and (4) Media code in ATIP—manufacturer name, media name, optimal laser power, etc. FIG. 3 illustrates the standard format for Block Addressing.

This method is used for recording in the groove of the unrecorded disk CDR or CDRW disk in compliance with the aforementioned standard. It is also possible to position the pickup over the land of the un-recorded disk however the adjacent groove wobble patterns interfere in such away to make the information incoherent and effectively useless with present art.

The proposed design is able to record on to the lands of these Orange Book compliant disk by using the adjacent recorded groove position information, recorded in the data subcode Q field (as defined in Orange Book standard), to find the position and then micro-stepping on to the land to start recording. The data being recorded will remain synchronised by using the wobble carrier frequency as a reference for position.

Further to this the data in the land will be given a unique position reference MSF (minutes:seconds:frames) by using a negative reference as used in previous art for the lead-in area of the recordable disk. This unique address will be used to designate the position of recorded audio tracks, data files, compressed audio files or other recordable material. In the first instance in the Program Management Area and for an open session or open disk in the second case within Table of Contents in a closed session, closed-disk or fixated disk. This will allow a maximum address of −99:59:74, minute seconds and frames.

The data recorded on the land will not be accessible by a standard CD-ROM or audio CD device but will be accessible by a proprietary player having the necessary electronic circuitry and firmware. The recording of this extra capacity will be an option available to the consumer on the aforementioned proprietary player. This extended play or capacity option increases the capacity of the CD by a factor of two and is applicable to both 8 cm and 12 cm disk formats.

It is possible to use the device to record standard ‘Red Book’ Audio for both recording thereof and for playback. When recorded in compressed format (as is the case for compressed audio), then if the disc is inserted into a standard ‘Red Book’ Audio compatible device, there is played back a brief audio message advising the user that the device is not compatible with ‘Red Book’ audio.

Whilst recording data is first written to the groove which is formed in a spiral starting at the ID of the CD and progressing to the OD of the disk. If the extended play option is selected then further data can be recorded on the lands between grooves again starting at the ID and progressing to the OD.

The groove recording on the extended play will be accessible by a standard CD-ROM, CD device, the firmware will ensure that this is possible, although not in all circumstances. In the case of the device being used to record a file of greater than the groove recording capacity (typically, 180 Mb for 8 cm media), this will not be possible.

The invention encompasses servo algorithms for micro-positioning the optical pickup over the groove and micro stepping on to land. An electronic circuit that is able to recover the carrier frequency and ATIP from the garbled wobble readback signal. This electronics is also able to record the position of the extended data on to the PMA and the TOC.

Double-Sided Disk.

Presently, CD recordable and rewritable technology utilises only one surface of the disc surface. In the following embodiment of the current application, the media is double-sided. It is possible to either stamp the media to replicate the recordable/rewriteable surface on two sides or alternativley to take standard single sided discs and to combine these to make a double-sided disc by simply bonding the surfaces together. The immediate and obvious benefit is in the doubling of the capacity.

FIG. 4 shows a cross-section through a substrate layer for a replicated CD 1. A label 2 overlies a protective layer 3. Underneath the protective layer 3 there is a reflective layer 4 and data pits 5 (typical depth 0.13 μm) are embedded in the surface of the transparent substrate 6. For a CDR/CDRW the configuration, the build up is similar; however, the reflective layer is a multilayer buildup of phase change sensitive and protective coatings. Typically, this will be 1.2 mm thick.

FIG. 5 shows in cross-section how two of these substrate layers 1 may be combined. The resulting “bonded disc” 10 is fabricated from two 0.6 mm thick discs, giving the same overall 1.2 mm thickness.

However, there is a problem which the present invention had to overcome in order to provide double-sided media. Simply, current compact disk media cannot be marked on the side accessed by the play and record head(s) as this would obstruct the optics. Therefore, the present invention seeks to provide a way of labelling a compact disk without obstructing the optics.

Means are provided to facilitate the marking of the media on the optical surface as discussed below. The media will however be required to be thinner to allow acceptance into a standard player which has been designed to accept the Orange book standard disc being 1.2 mm thickness. Alternatively and for the method as described whereby the two standard discs are bonded together, the disc will be used exclusviely in a proprietry disc writing system or player. The discs can either be considered as being separate and have independent PMA and TOC or could be combined as would be practicle in the instance where the drive is being utilisied as a data storage device, whereby the user interface would indicate upon transfer when the disc was to be turned over. This method can be applied equally to 8 cm or 12 cm format.

Automated Disk Labeling.

This invention enables the recording of visible text or images onto the surface of a CD recordable or rewriteable disk which complies to the ‘Orange Book’ standard. The recorded text or image can be used for in the first instance the cataloguing of the disk for the users collection or library of recorded material. It can also be used for the purposes of providng a label which does not obscure the optics of the read/write laser(s) as described above. The recording of the image can be further used as a copyright protection watermarking system with the recording of a trademark or unique indentification number for authenticity. Techniques for marking of optical data discs with a unique characteristic marking are well documented. The marking, referred to as a ‘watermark’, can be a name, logo, design, picture or other pattern which is applied within the structure of the data disc. Typically the watermark is applied to the master disc, and will therefore be reproduced in all production replica discs through the use of standard stamper and replica processes. The current invention relates to the marking of a recordable disc whereby the title content cannot be pre-stamped.

The present art in CD recording allows data to be recorded onto a disk with a land and groove structure, this structure being necessary for the steering of the servo when the disks have not been recorded with data. These disks are then recorded with data within the grooves with the land being left unrecorded.

The proposed design will record a visible image or text on to the land area of the disk by burning picture elements (pixels) on to the lands of the disk in a predefined area in the case of CD recordable media. In the case of CD rewritable media the pixels will be formed by changing the state of the coating of the phase change media into either amorphous or crystalline structure. The burning or phase change of the media will in both cases create a contrast difference with the surrounding lands or the randomly recorded grooves. The proposed invention uses a matrix of these pixels to create an image in a similar manner to other display device, the image may be restricted to a predefined area of the disk or cover the whole disk area. FIG. 6 shows an example of images displayed on a compact disc 20 by creating a plurality of pits 21 which contrast visibly with a background (land structure) which is normally of high reflectance.

The invention entails the design for an electronic circuit to allow the direct recording of the image on to the disk without the use of data encoding circuitry. The design of a servo algorithm for positioning the optical pickup laser beam over the land area of the disk. It also comprises the design of an algorithm and electronics for decoding the absolute position of the laser beam over the disk in order to accurately record the pixels and hence the image. The design further includes an algorithm for mapping a digital image in any format or text onto the CD disk surface.

In yet another embodiment and by the application of a phase change state coating to the disc surface, being translucent in its inactivated state, to laser light in the region 635-650 nm although not exclusively, it is also possible to write to the reverse side or non data storage side of the disc. It is possible to servo and track effectively and navigate the disc on the reverse side. To facilitate this however it is first necessary to detect that the data is being streamed in the opposite sense and in so doing commanding the motor to rotate in the opposite direction. Given the proximity of the optical surface to the coated surface. (this is not the case on the recording surface given that there is some 1.2 mm separation). The laser energy is of sufficient intensity as to cause marking to the coating. As for any light activated coating being of a frequency similar to that of natural sunlight then prolonged exposure will result in degradation of the image. This however likewise applies to the media.

An interesting potential application of this technology would be the use of CD-R or CD-RW media as electronic money or as smart cards in which fingerprint identifiers, such as the photograph, physical fingerprint or iris pattern of the owner, could be displayed on the disc itself.

3. Optimising Speed Operation for Power Saving.

Use of an optical recording disc, typically in reduced capacity being 8 cm compared to the standard disc being largely 12 cm combined with a recording device with primary purpose being to reduce power consumption. This format complies with the orange book standard and would allow for the recording of and playback of the disc within a standard CDROM/CDR/RW with appropriate utility for decoding of the compressed audio algorithm or alternatively as a data storage device. This is equally applicable to a standard red book audio player that would likewise benefit from the reduced power consumption. As well as 8 cm discs, sizes such as 4 cm and 6 cm are also beneficial.

By using a smaller format disc there is an inherent benefit in the reduced windage being a frictional loss. The loss is a function of the radius rˆ 3 and a function of the velocity vˆ 3/2. By reducing both the disc speed and the radius of the disc then there is significant frictional loss advantage. The disc spindle frictional loss is dominated by the viscous friction likewise being a function of the vˆ 3/2. In an embodiment of the current invention, given that the data is in a compressed format, it is possible to consider reducing the operating speed to below the 1× Orange book standard. Current applications range in × speeds of between 1× and 50×. It is well within the standard dynamic range capability of a spindle motor and controller to operate at the suggested reduced × performance typically 0.2× to 8× being a factor of 32. At such reduced speed the losses within the motor are considerably less, as are the windage losses for the rotating disc. Additional efficiency gains are made given that in normal operating mode, i.e. on playback of compressed audio format music or compressed data format, the battery consumption is optimised for charge/discharge efficiency and also for maximum output charge capacity.

Windage loss is the resistive torque experienced by the surface of a spinning disc due to the resulting air friction. In an attempt to quantify the resistive torque it is first necessary to establish the nature of the flow regime, which can be either laminar, turbulent or transient. Determining the flow regime is a simple matter of calculating the Reynolds number Re (see equation 1) for an axis-symmetric flow system

Re=R²ω/ν equation 1

where R [m] is the disc radius, ω [rad/s] the rotation speed and ν [m²/s] the kinematic viscosity of the fluid within which the spinning disc is immersed. A system with a Reynolds number below 3×10⁵, will have a laminar flow regime, signifying that the viscous forces will be a predominant factor in the determination of the resistive torque. For a disc, of 12 cm diameter, to maintain a laminar flow regime in air (at sea-level) it must not spin faster than 11,740 RPM, and not faster than 26,640 RPM for a 8 cm diameter. This corresponds to CD data transfer speeds of 17.4× and 39.5× respectively.

In the light of these considerations, the resistive torque M due to laminar flow on a spinning disc is directly proportional (α) to the product of the shearing stress τ_{w}, area R² and arm R (see equation 2)

Mατ_{w}R²R equation 2

Shearing stress is given by

τ_{w}αρRω²δαρRω\sqrt{νω} equation 3

where ρ [kg/m³] is the fluid density and δ [m] is the height of the boundary layer, which is independent of the disc radius i.e. δα\sqrt{ν/ω}. Through the dimensionless integration of the Navier-Stokes equations and continuity for an axis-symmetric system, followed by the application of appropriate boundary conditions, we are able to eventually derive empirically the resistive torque for one side of a disc:

2M=0.616πρR⁴(νω³)^{1/2} equation 4

Equation 4 confirms the fact that by using a smaller format disc an inherent benefit in reduced windage loss arises, as the resistive torque M is proportional to R⁴.

Further, equation 4 shows that the resistive torque M is also proportional to ω^{3/2}. As a result, reducing both the disc rotation speed and disc radius reduce significantly the frictional losses, therefore reducing power consumption and prolonging battery operation times. FIG. 7 shows windage power loss values, both experimental (solid lines) and theoretical (dotted lines), for 8 cm and 12 cm disc formats.

Further benefit is obtained by means to reduce the drag coefficient of the disc. An optical disc in a typical embodiment will have an optical surface onto which the laser light will record or readback the recorded data by discriminating the light absorption between phase change states. On the other side, the title information will either be printed, in the case of a pre-titled disc, or in the case of a recorded disc, a label will be added or marking made using a permanent marker. It is possible to reduce the drag coefficient of the disc by careful consideration to the surface condition of the label. It is possible to reduce the drag coefficient by selectively texturing the surface although the benefit of this will not be apparent at low × speeds and is more applicable to high-speed player, writing systems. The disc enclosure is designed in such a manner as to reduce the relative velocity of airflow at the disc interface thus reducing the windage. Re-circulation of the air should be avoided to prevent pumping action through the drive. The drive enclosure is designed with reduced clearances to the disc. This is made possible by the reduced disc diameter and by the clamping method as described in item 4. There is a secondary advantage in that it is possible to reduce the drive format height, being a key consideration for the application of a portable device. Also of equal importance in a portable application is the user perception of acoustic noise and vibration level that will be heightened. Using the small disc will result in reduced out of balance forces, reduced acoustic noise and windage forcing frequencies.

FIG. 9 shows schematically the relationship between the size of gap s (see FIG. 8) and the associated windage power loss for a disc 30 in an enclosure 40. There is a decrease in windage power loss with a decreasing gap s due to the following:

A smaller gap s signifies a smaller enclosure volume, and therefore also a reduced mass of air that will be accelerated.

The surface area in contact with the air flow is also reduced

Smaller enclosure volumes are less suceptible to vortex formations. In a preferred embodiment, a disc of diameter 8 cm will be spun at an angular velocity of 300-2500 rpm with a gap of 1-3 mm, preferably 2 mm.

An individual enclosure can be designed by calculating the optimised gap s for a particular angular velocity and disc size, ensuring there is sufficient sway space for anti-vibration mounts (typically 0.5-1 mm sway space is required).

Typical of the portable application, a solid-state memory buffer which will afford the disc recording device a period of anti shock operation, which will make the output immune from disruption from sustained periods of vibration. It is possible to optimise the disc speed to maintain a constant buffer size. This will be achieved by an intelligent application monitor which when combined with ECC sensing will determine the level of errors being reported and the amount of data throughput acquired which will spin the disc at a higher rpm to ensure that the buffer size is maintained. Alternatively the user is given the option to toggle between modes of operation i.e. rugged terrain, stationary mode etc.

In another embodiment of the design, being a “slimline” version, the motor rotor is an integral part of the disc. The rotor being an integral part of the disc label. This label can also be used for disc security and authentication. Such a label would also ensure that only proprietary or licensed media was used within the drive.

FIG. 11 is an illustration of the guide vane design intended for the enclosure interior. The guide vane angle θ changes with radius and is derived from a turbulent flow calculation. Guide vanes are an effective means of guiding the flow in a desired direction. In this case flow is guided in a calculated direction in an attempt to extend laminar flow and minimise turbulent—therefore minimizing windage-enhancing effects such as re-circulation and vortices. The guide vane may be an integral part or separate to the enclosure.

Disc Surface Texturing

Turbulent flow generally produces greater drag on the disc surface than laminar flow. By controlling the random nature of re-circulation and vortex formation, the magnitude of turbulent drag can be reduced. Applying a vortex-generating surface texture on the spinning disc can be used to forcefully enhance the natural mixing of turbulent flow and therefore delaying large-scale separation. In high-speed spin applications turbulent flow will always form and guide vanes can only used as an aid to stall this formation.

FIG. 12 is an illustration of the fundamental vortex generator shape 50. Typically this will be around 0.25 mm thick. We can see in FIG. 11 how the vortex generator shape 50 is applied throughout the disc 30 as a texture, noting the following characteristics:

The radius at which the texture starts is determined by the position of where turbulent flow starts to form. Relevant calculations are made to establish this position for a particularly sized disc and rotation speed.

The orientation of the surface texture is derived from fluid flow calculations.

The texture can be an integral part of the disc or can be applied later, e.g. in the form of an ink using standard inking technology.

Mechanical Interlock/Brake

Upon commanding a disc eject from the disc device, the disc will be required to spin down prior to the disc being offered to the user for removal from the drive. At high operating spin speeds, the disc spin down time for regenerative braking will be excessive and unacceptable to the user. In such circumstance it is possible to force a disc spin down by making mechanical contact. In normal applications the disc is contacted by a “brake block”. This is commonly in the form of a pad contacting the outer disc edge. This is undesirable and a better system is for the centre hub/interlocking mechanism to actuate a brake integral with the float hub, upon lifting of the enclosure lid. The interlock hub also activates the media clamping. This ensures that only light force is required to the hub centre on loading and unloading of the cartridge onto the spindle centre. It would be possible to offer such a system whereby there would be no retention and the disc would be loose fit onto the hub. This however would not be suitable for hand held operation, portable use. The media clamping being positively actuated by the lid closure retains the media to hub spacing allowing for closer tolerancing of the drive mechanical heights and clearances, reducing the overall height.

Play List Recording, Editing and Recording to Disk.

This invention is a method for organising a large ammount of audio or video material recorded on a CD-recordable or rewriteable disk into an organised programme or playlist. This playlist is then recorded onto the media containing the material and can be selected the next time the media is placed in the recording device. This number of these playlists can be seperated recorded each having a plurality of tracks or clips references and containg a minimum of one track reference and a maximum being the totality of recorded material on the disk. These playlists are either automaticaly named or assigned names by the user. Once recorded these playlists can be added to or edited as many times as the capacity of the disk will allow.

The invention comprises a player/recorder with the capability of recording data or music from a PC or electronic device onto a CD recordable or rewriteable disk, a display that allows recorded data (music/video) to be displayed and a set of navigational keys that allows tracks to be selected and the playlist edited. The invention further comprises a software utility progarm for PC which allows playlists to be edited and re-edited and saved on to the disk in the device such that the selected playlist can be played on the device remote to the PC.

Title Browser.

This invention is an extension of the CDR based compressed audio player that allows the titles of music tracks or video clips recorded on the disk to be found by a search of the disk the browser will provide a list of suggestions based on the letter keyed in and and as the number of letters selected this list will converge on the required track or video clip. The invention is in effect a interactive browser of the material recorded on the disk that allows the user rapid access to material recorded on the disk.

The invention is a device that records compresed music or video or other data type on to a CDR or CDRW media and allows the user to access any track or video clip or other data quickly via a keypad and display. The device comprises electronic hardware and software as well as search algorithms for minimising the time to access any piece of content stored on the CDR or CDRW media. Further the device then allows any selected material to be played using the device be it music or video or games and added to a playlist or transferred to another device such as a PC.

This invention is particularly beneficial for a device like that disclosed herein which has the capacity to store a large number of tracks. It could equally be applied to storage on a high capacity solid-state or magnetic recording device.

Further modifications and improvements may be incorporated without departing from the scope of the invention herein intended.

1. A method for recording information on a recordable compact disc having a groove and land, the method comprising the steps of identifying a position in the groove of the recordable compact disc, microstepping onto the land adjacent to this position and recording information on the land from the resulting position onwards.

2. The method of claim 1 further comprising the step of establishing the position in the groove of the recordable compact disc by reading position information from the data subcode Q field.

3. The method of claim 1 or claim 2 wherein data recorded in the land is allocated a negative position reference, this reference being recorded in the program management area or table of contents.

4. A method for recording information on the land of a recordable compact disc, the method comprising the steps of identifying a position in the land by recovering the wobble readback signal from parts of the groove adjacent to the land.

5. A method for recording visible text or images on the surface of a recordable compact disc comprising the steps of recording an array of visible pixel elements on the land of the recordable compact disc.

6. The method of claim 5 wherein visible pixel elements are recorded by abrating CD-R media.

7. The method of claim 5 wherein visible pixel elements are recorded by laser induced phase changes on CD-RW media.

8. A double-sided CD-RW media having a groove and land pattern on either side and further having an image recorded by the method of any of claims 5 to 7 so as to enable the top and bottom sides to be differentiated.

9. A personalised data storage media comprising a recordable compact disc with an image displayed thereon, wherein said image acts to identify the authorised user of the personalised data storage media.

10. A method of saving power in a compact disc player comprising the step of reducing the playing speed to below the orange book minimum speed and storing music thereon in a compressed data format.

11. A compact disc having a textured surface adapted to reduce the drag coefficient of the disc.

12. The compact disc of claim 11 wherein the textured surface comprises a plurality of vortex generator means.

13. The compact disc of claim 12 wherein the vortex generator means have the shape illustrated in FIG. 12.

14. A compact disc player comprising a solid-state memory buffer and a means for adapting the speed at which the compact disc is played.

15. The compact disc player of claim 14 wherein the means for adapting the speed at which the compact disc is played acts to maintain a constant data buffer size in the solid-state memory buffer.

16. The compact disc of claim 14 or claim 15 wherein the means for adapting the speed at which the compact disc is played monitors the rate at which playback errors are reported and adapts the speed to the lowest speed compatible with a given error rate.

17. A braking means for stopping the rotation of a compact disc in a compact disc player having a float hub, the braking means being integral to the float hub.

18. The braking means of claim 17 being positively activated by lid closure.

19. A data storage medium which has a personalised play list indicating the order in tracks or data files shall be played.

20. The data storage medium of claim 19 wherein the tracks or data files are audio files, video files, digital still photographs, presentation material or any other type of files which a user may wish to have played in a preferred order.

21. A method for preparing a data storage device with a customised play list comprising the steps of selecting a plurality of tracks or data files and an order for playing said tracks or data files on a computer and then writing said list of tracks or data files and play order onto a data storage device.

22. The method of claim 21 further comprising the steps of selecting and writing on the data storage media information about an associated software application which can play said track or data file and the logical address where said track or data file is stored on said data storage device.

23. The method of claim 21 or 22 wherein tracks or data files are recorded on the data storage media after recording play list information on the data storage device.

24. The method of claim 23 further comprising the step of recording additional information on the data storage media after recording said play list information.

25. The data storage medium of any of claims 21 to 24 wherein the tracks or data files are audio files, video files, digital still photographs, presentation material or any other type of files which a user may wish to have played in a preferred order.

26. A method for selecting for play a track or data file recorded on a data storage device wherein each track or data file has one or more alphanumeric identifiers, the method comprising the steps of inputting one or more alphanumeric characters, presenting a list of track or data files which have identifiers beginning with said character or characters to a user, inputting from a user an identifier of a particular track or data file and then playing said track or data file.

27. The method of claim 26 wherein an alphanumeric identifier is selected from a list consisting of: title, genre, artist, author.

28. A compact disc player having a disc enclosure interior, said enclosure interior having guide vanes thereon.

29. The compact disc player of claim 28 wherein the pattern of the guide vanes is as shown in FIG. 10.
